(19) United States
(12) Patent Application Publication
(10) Pub. No.: US 2009/0326983 A1
(43) Pub. Date: Dec. 31, 2009

(54) DATA COLLECTION AND DATA MANAGEMENT SYSTEM AND METHOD FOR USE IN HEALTH DELIVERY SETTINGS

(76) Inventor: Linda H. Kunz, Cedarburg, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/302,241

(22) PCT Filed: May 24, 2006
(86) PCT No.: PCT/US2006/020181

§ 371 Date: Apr. 3, 2009

(51) Int. Cl. G06Q 50/00; G06F 17/30; G06Q 10/00; G06Q 40/00

(52) U.S. Cl. 705/3; 707/104.1; 707/10; 707/101; 707/E17.005; 707/E17.032; 707/E17.044

(57) ABSTRACT

A data collection and data management system and method enables an entity user, such as a corporation, that owns and operates more than one type of health delivery setting to coordinate and control patient initial placement and or transfer between multiple health delivery settings to optimize care, improve utilization of resources and staff, and coordinate reimbursement outcomes for multiple health delivery settings. Base raw data is input by the multiple health delivery settings, translated and cleaned for use in a standardized format, and then processed for multiple uses in accordance with a pre-programmed scheme.

### FIELD OF THE INVENTION

The present invention relates generally to the fields of data collection and data management. It also relates generally to systems and methods that are used in the fields of data collection and data management. More particularly, it relates to a system and method of data collection and data management that coordinates health and business operation data collection across more than one health delivery setting. It also relates to a system and method that enables an entity user, such as a corporation, that owns and operates more than one type of health delivery setting to coordinate and control patient initial placement and or transfer between multiple health delivery settings to optimize care, improve utilization of resources and staff, and coordinate reimbursement outcomes for multiple health delivery settings.

### BACKGROUND OF THE INVENTION

The United States government has mandated the availability of portable and private Electronic Health Records (EHR) on a network for access by a patient, and the patient's caregivers, each being dispersed in multiple locations. The caregivers are located in various Health Delivery Settings (HDS) and should have access to a required data set, all to be mandated by the United States government. The federal government's current working model for the EHR is for health care providers to transmit data to a regional network where other health care providers in the region surrounding the patient's home can have immediate access to patient information for use in emergency and ongoing care-giving situations. This federal model for an EHR “network” to serve in the geographical care-giving region is called a Regional Health Information Organization for sharing (RHIOs) and, to date is best demonstrated for eldercare where it has been tested in a multi-county area in central Indiana. Common data fields and “HL7” format (HL7® is a registered mark of Health Level Seven, Inc., a New Jersey corporation) have been used for data sharing in the central Indiana RHIOs, also known as the Draft Standards for Trial Use (DSTU).

Corporate entities often own and/or manage more that one type of HDS when serving the care needs of the elderly. The frail elderly can be cared for in a variety of HDS but the most common ones are hospitals, hospitals with sub-acute care units, rehabilitation (or “rehab”) hospitals, Skilled Nursing Facilities (SNF), Assisted Living/Assisted Living Facilities (AL/ALF), all with Licensed Care Givers available on the premises or on call, and Ambulatory Care Centers treating the elderly.

Many corporations own two or more types of HDS. For example, hospitals frequently own attached sub-acute SNF. SNF “chains” often own and run an AL/ALF which may or may not be attached to the SNF property. It is also not unusual for SNF chains to own SNFs in several states. Furthermore, area hospital groups often own and operate freestanding SNFs, attached sub-acute nursing facilities, and rehabilitation, or “rehab,” hospitals.

The individual HDS operate independently of others, each HDS having medical care, documentation and “best practice” procedures that are specific to it. These practices are often described using very different medical terms embedded in very different, but required, patient-assessment documents and forms—often with this language conveying best practices that are specific to the HDS and being required to flow through to specific required assessment documents and submissions for accurate reimbursement. For example, detailed descriptions needed for patient Activities of Daily Living (ADL) is documented for both care and reimbursement purposes very differently in each of the HDS situations mentioned above.

What is needed is a system and method for corporate entities having multiple HDS situations to create “interoperable” and “shared” electronic data in their corporate neighborhood of one or more HDS. Only then will they be enabled to share within the corporate neighborhood consistent, accurate and coordinated data presented in the best practice language of the HDS needing reports and using data merges originally collected in one or more corporate owned HDS. Thus each HDS will have the benefit of using their specific best practice actions and language but can operate from a single data source.

The corporate groupings that have one or more different types of HDS operate with aligned budgets and financing. The reimbursement of each HDS is also very different. Accordingly, what is also needed is a way that each HDS can be linked by a common data base of clinical and reimbursement focused information. Each HDS not only has a very different mechanism for reimbursement for care, but some have multiple payer sources including federal Medicare Part A, federal Medicare Part B and Medicaid which is regulated by the state in which operation of the HDS takes place, with required documentation and assessment tools chosen by the particular state of HDS operation. Some state examples include “TILES” in Texas, “PRI” in New York, and “MMQ” in Maine. Various other states use standard reimbursement tools but exercise their right to customize how the data is used to rate payments by “add on” questions in what is typically called section “S” for state authority.

Another problem that can arise is that regional private pay insurance companies often rely on specific Minimum Data Set (MDS) outcomes for payment. MDS collection is accomplished by means of a form that is used, for example, for nursing home resident assessment and care screening. The form is configured to ask for information that is mandated by Medicare for proper patient reporting and provider reimbursement. The MDS form includes a plurality of patient-sensitive considerations including, for example, observation and rating of patient difficulties or assistance needed to perform life-sustaining ADLs, patient communication/hearing patterns, mood and behavior patterns, physical functioning and structural problems, special treatments, and so on. Also, some states, such as Minnesota, regulate equalization of service payment rates for all non Medicare payer sources which can include private pay, insurance and Medicaid.

In view of the foregoing, it can be appreciated that a single episode of care for a frail elderly patient can be reimbursed by three to four payer sources with one or two of them paying for separate, but overlapping, treatments or sequential time periods of the same episode of care. All payers use different mechanisms for payment for reimbursement for care of the frail elderly that may require different “best practice” medical assessment data and reporting templates for each payer source.

For example, it is known that SNFs gain reimbursement from the submission of the MDS form or the MDS information. The same is true of sub-acute nursing facilities. Rehab hospitals, on the other hand, gain reimbursement from the submission of a special Inpatient Rehab Assessment tool (IRFPAI). An AL/ALF can gain reimbursement from the submission of the home care assessment form called OASIS (Outcome and Assessment Information Set) when the patient needs skilled care. Hospitals gain lump sum reimbursement from the submission of a billing form that assigns accurate diagnosis (procedural/diagnosis or Diagnosis Related Groupings (DRG) codes) and accurate CPT-4 codes set fee payments. In outpatient clinics, doctors' notes are used to support CPT-4 procedures and to set fee payments. As such, it can be readily understood that a corporate entity that focuses on elder care and owns or manages two or more types of facilities within different HDS faces complex data coordination and reporting needs. What is needed is a system and method of data collection and data sharing that coordinates health and business operations across more than one HDS. To date, no system of data collection coordinates health and business operation data collection across more than one HDS.

### SUMMARY OF THE INVENTION

The system and method of the present invention provides for data collection and data management that also coordinates health and business operation data collection across more than one HDS. It also provides a system and method that enables an entity user, such as a corporation, that owns and operates more than one type of HDS to coordinate and control patient initial placement and or transfer between multiple HDS to optimize care, improve utilization of resources and staff, and coordinate reimbursement outcomes for multiple health delivery settings.

The system and method of the present invention is novel and enables a corporation, or other entity, owning and operating more than one type of HDS to coordinate and control patient initial placement and/or transfer between one or more corporate HDS for optimal care; provide for corporate-wide effective resource and staff utilization; provide for effective and coordinated reimbursement outcomes for multiple HDS; and to provide an effective corporate-wide means for communication with the local RHIOs, all of which meet federal requirements for a portable yet private EHR.

The core of the system and method of the present invention is that individual HDS and department users input the medical information that they gather into the system, all consistent with their best practices and language. The system is capable of using translators that are specific to each HDS and department user to translate and then convert the information to data for input into a common database. In this manner, each form of input data is translated into common elements of care and clinical documentation, all with continued links to originating HDS details. This creates, in effect, a single-source, clean and accurate data base. At any time in the future, a HDS-specific algorithm can call up data, analyze it and calculate the parameters needed for decision making at either an HDS, or the corporate entity level. Ultimately, the entity-wide Corporate Entity Information Organization for Sharing (CEIOS) system can conduct constancy checks to compile and transmit the most accurate corporate entity-wide health information to the RHIOs. Prevention of inconsistent reporting from multiple source medical documentation reduces the chance of payment reversals by Medicare and other payer source auditors. The CEIOS system can report in decision-making or reimbursement formats specific to the HDS that the patient is being treated in currently or more than one setting or language set when an internal corporate transfer of the patient is being considered. When the transfer is being considered a proform a reimbursement and care performance criteria can be reported to predict the potential for good care in a different HDS and the relative cost and reimbursement outcomes. With this system and method, a corporate entity could make decisions having the benefit of shared HDS data that is interoperable.

Under the CEIOS system, data can be presented in the best practice language of the HDS needing reports and using data merges originally collected in one or more corporate-owned HDS. Each HDS will have the benefit of using its specific best practice action documented in its specific language but can operate from a single data source. It can be used to produce pro-form a reimbursement and shared clinical observations. It provides for fully portable health data within the corporate neighborhood that can be presented in the specific best practice language of any HDS, any required assessment format or reimbursement application formats. The method and system can produce the required corporate reporting format for budget control and utilization for multiple HDSs that exist under the same corporate ownership.

The concept disclosed by the present invention can also create corporate-wide “just in time” staffing, which should decrease the shortage of healthcare staff. At the present time, this inventor is unaware of any automated system that informs staff of what needs to occur, or that can tell staff when a last occurrence took place, for the maximized benefit of the patient. Most correspondence with and between healthcare staff is verbal or is realized by reviewing written information, not via an automated system that gives information immediately and uniformly across all HDS. This concept provides efficiencies in the performance and assignment of healthcare duties and in the maximized utilization of facilities and staff, all at a realized savings in the overall cost of managed healthcare.

### BRIEF DESCRIPTION OF THE DRAWINGS

FIG. 1 is a schematic diagram illustrating a RHIOs of prior art.

FIG. 2 is a schematic diagram illustrating a shared-data model according to one embodiment of a CEIOS system configured generally in accordance with the present invention.

FIG. 3 is a schematic diagram illustrating the data and process flow through the CEIOS system shown in FIG. 2.

### DETAILED DESCRIPTION

As discussed above, the system and method of data collection and data management of the present invention serves to coordinate health and business operation data collection across more than one health delivery setting. It also enables an entity user, such as a corporation, that owns and operates more than one type of HDS to coordinate and control patient initial placement and both patient and staff transfer between HDS to optimize care, improve utilization of resources and staff, and coordinate reimbursement outcomes for multiple HDS. This system and method will be identified herein as a Corporate Entity Information Organization for Sharing, or CEIOS. A powerful “value add” from the CEIOS concept is the ability to optimize skilled nursing and nursing assistant labor utilization within the extended patient care environment.

One of the most significant challenges facing the healthcare system today is recruiting and retaining patient care staff. Many organizations are short staffed. Optimizing care giver efficiency, monitoring their performance, and insuring that patients are receiving the right level of care are all significant issues. In today's environment, regular-scheduled patient care events (toileting, turning, etc.) are manually scheduled, performed, and recorded. As unscheduled events occur (i.e. patient fall, elopement, etc.), care givers often find it difficult to effectively manage the unscheduled event and to remain on task for the scheduled events. Additionally, personal performance variation, attention to detail, adherence to facility guidelines for duration of personal and meal breaks, and lack of supervisory oversight all complicate the ability of the healthcare facility to effectively care for the patient while optimizing care giver utilization. The CEIOS concept effectively addresses these staffing concerns. That is, a primary benefit from CEIOS is that it allows the utilization of real time data and patient care and acuity data to schedule, monitor and optimize care giver utilization and gain accurate reimbursement, all across multiple HDS owned or operated by a single corporate entity.

In the experience of this inventor, the availability of historic information that reflects patient acuity information, current census trends, and caregiver capabilities indices, personal productivity, and availability information, coupled with an automated scheduling toolset, helps create the initial staff schedule template for the shift, day, and week. As care occurs on a normal scheduled basis, caregiver time and attention is captured and monitored. Demand anomalies are noted and reallocation occurs dynamically. Excessive personal time away from care is also captured for employee remediation. Care giver productivity combined with outcomes analysis is used to rate the caregivers task performance skill set. Demand spikes and care give ratings on skill sets are noted to facilitate tactical staffing and strategic facility staff rebalancing planning. For unscheduled events, rather than react, the care giver, on a “just in time” basis, can be redirected, through a personal wireless communication device to those events that require his or her immediate attention. As unscheduled events occur, scheduled tasks that may be in jeopardy can be redirected on a “real time” basis to a task-qualified care giver who may be under-utilized, or is performing less critical tasks. An ancillary value of real time capture and optimization of caregiver utility in the CEIOS environment results in significant additional benefits affecting the quality of patient care, caregiver efficiency, and facility financial performance. Financial planning and reporting across multiple HDSs is also integrated into the system. Financial reimbursement presentations and submissions require specialized language and know-how that is specific to each HDS, often so specialized that HDS specific reimbursement staff, often called “Utilization and Reimbursement Specialists,” are needed for each HDS. A CEIOS used by the corporate entity enables the coordination and translation of reimbursement sensitive information for use across multiple HDSs, all compiled in the format and preferred language for HDS-specific reimbursement or for the corporation's needs.

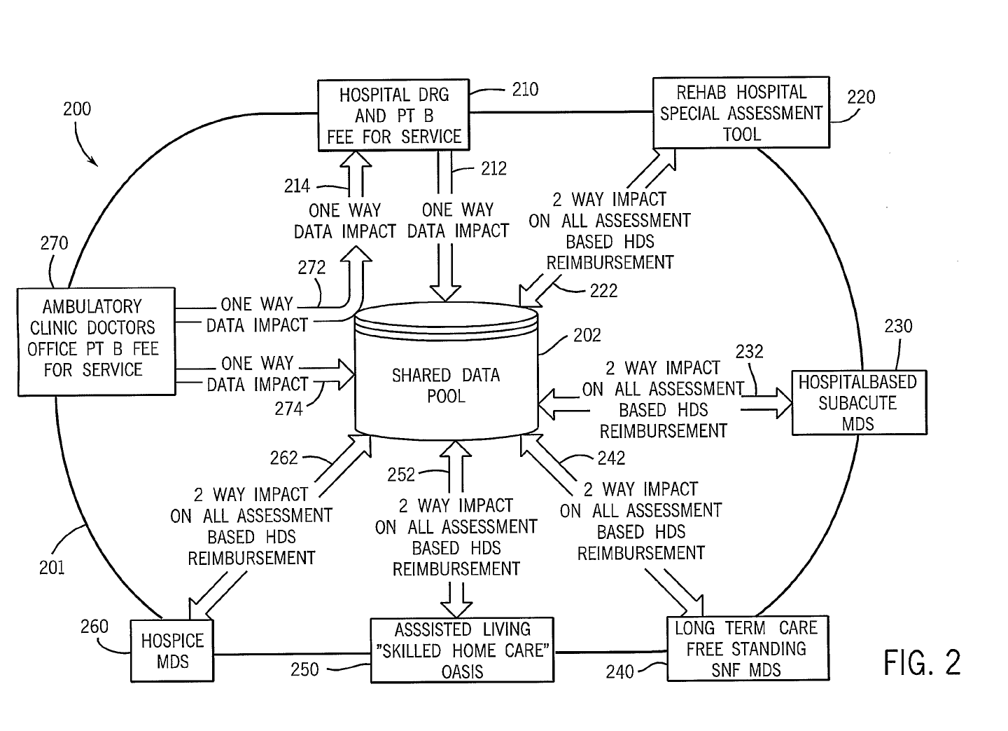

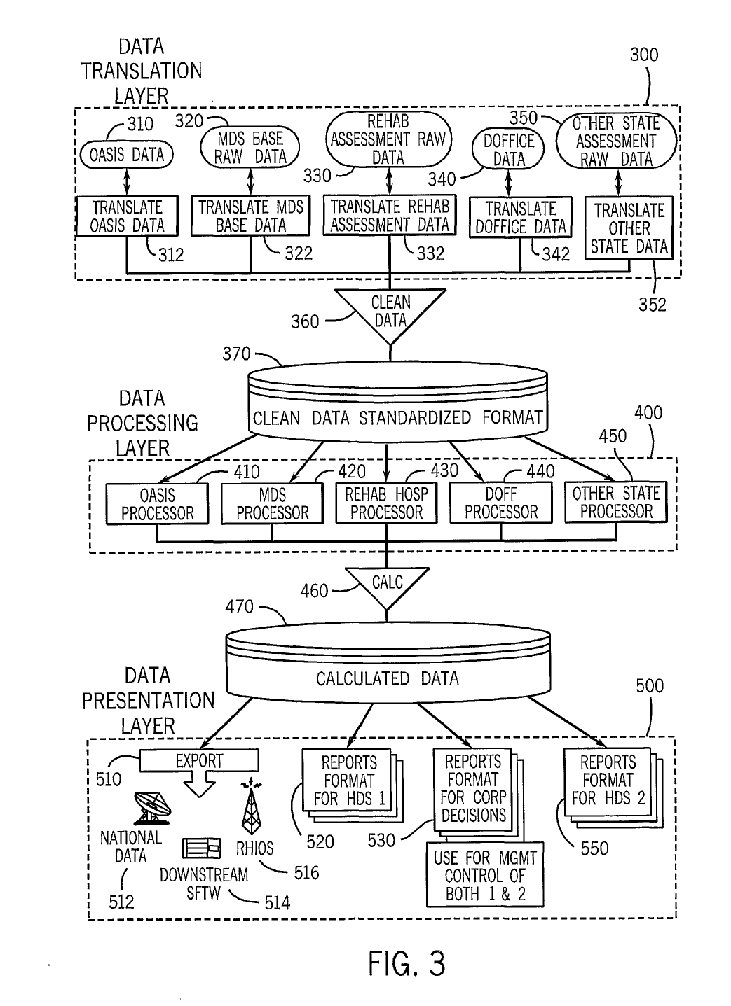

Referring now to the drawings in detail, wherein like numbered elements refer to like elements throughout, FIGS. 2 and 3 illustrate the CEIOS concept or environment, generally identified 10, that is configured in accordance with the present invention. Although a specific configuration of the CEIOS concept is presented herein, it is to be understood that the invention is not limited to the specific configuration disclosed and that any number of configurations could be presented, all of which are contemplated by the method and system of the present invention.

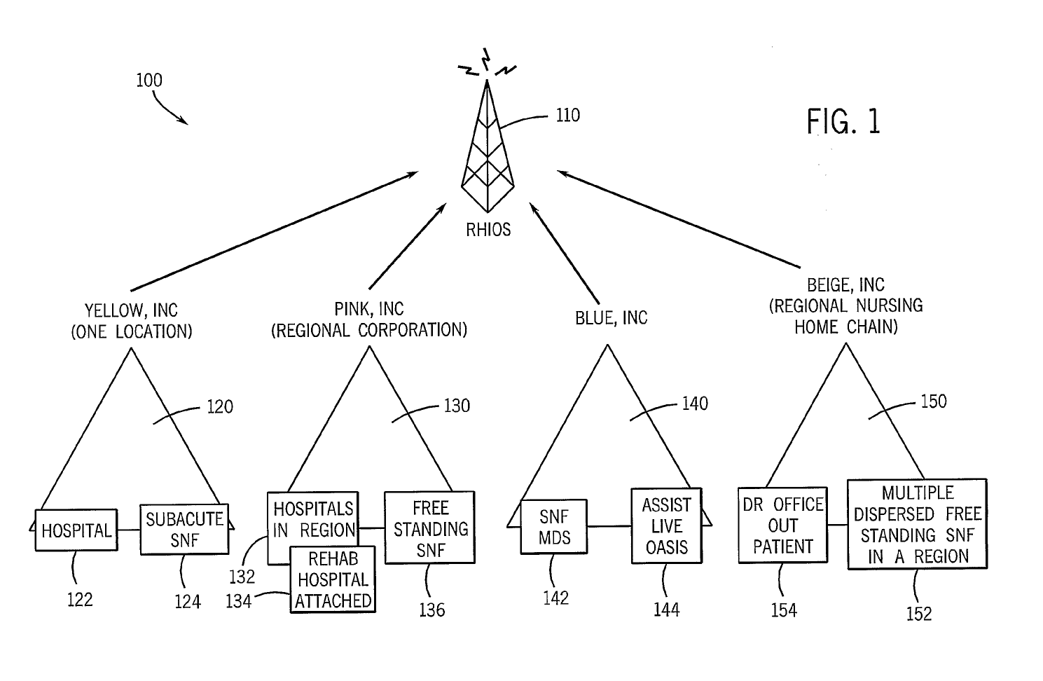

FIG. 1 shows a RHIO system 100 configured to be serviced by, and electronically connected by means of, a transmitter and receiver facility 110. As shown, the RHIO system 100 includes the healthcare facilities of a number of fictitious corporate entities 120, 130, 140, 150, the entities being identified solely for purposes of explanation of the existing art. For example, Yellow, Inc. 120 is one corporation that owns and operates a hospital 122 and a subacute SNF 124. Pink, Inc. 130 is a regional corporation that owns and operates one or more hospitals 132 in a region. Pink, Inc. 130 also owns and operates an attached rehab hospital 134 and a free-standing SNF 136. Blue, Inc. 140, another corporation, coordinates the work of SNF care givers and physicians 142 and an AL facility 144. Finally, Beige, Inc. 150 is a regional nursing home chain that owns and operates multiple free standing SNF 152 dispersed throughout the serviced region. Beige, Inc. 150 also owns and operates a number of doctor offices and outpatient clinics 154 in the region as well. Each corporate entity 120, 130, 140, 150 is electronically “linked” to the others in the region by means of the RHIOs.

In the RHIOs, a patient may be directed to a subacute SNF 124 of Yellow, Inc. 120 by a discharge planner at one of the regional hospitals 132 of Pink, Inc. 130 upon completion of his or her acute treatment at that facility 132. The shortcomings of data maintained in the RHIOs is that, by necessity, data transmission to the RHIOs requires “uncoupling” from HDS-specific best practice data detail that was originally produced in the corporate neighborhoods. This uncoupling can best be observed in the draft standard functional profiles for use of HL7 in an EHR system and RHIOs. RHIOs data can be retrieved by a non-originating HDS within a corporate neighborhood but it will have lost the advantage of the originating HDS's best practice detail, all of which has been converted into the second HDS's own specific language. Such RHIOs “filtered” information would be devoid of links to the vital decision-making details that can be used to create actionable corporate wide knowledge. RHIOs filtered data cannot be used to gain coordinated information in a multiple HDS operation. HDS or corporate knowledge that is fully interconvertable and interoperable can be use to make a decision. Maintaining the linked details in a corporate environment for use in alternate corporate or HDS settings can provide decision supporting knowledge that is lost by the current HL7 draft standards of the current RHIOs working model.

The CEIOS system of the present invention has eliminated the foregoing shortcomings. Referring generally now to FIG. 2, it is a diagram the generally describes the data flow and data relationship between multiple lines of business all of which are electronically interconnected by means of conventional background technology, including computer hardware, including one or more servers and peripheral equipment, and basic software architecture. The circular configuration 201 of the diagram around a shared data pool 202 is representative of the interrelated nature of patient data in the CEIOS system 200. It is also representative of the interrelated nature of patient data in the industry. In general, it can be said that data transmitted electronically from each source may be used by many applications. It is to be understood, however, that any number of variations within the CEIOS system 200 may exist, each being covered by the system and method of the present invention. As shown, the CEIOS system 200 illustrated in FIG. 2 includes caregivers that are located at various HDS comprising, for example, a hospital 210, a rehab hospital 220, a hospital-based sub-acute unit 230, a long term care, free-standing SNF 240, an AL 250 with “Skilled Home Care” capabilities, a hospice 260, and an ambulatory clinic 270, which might be a doctors' office. The system and method of the present invention is not limited to the specific array of HDS mentioned here. Each HDS 210, 220, 230, 240, 250, 260, 270 is able to provide information to, and receive information from, the shared data pool 202. Each HDS 210, 220, 230, 240, 250, 260, 270 uses a different patient-assessment document or form. For example, the hospital-based sub-acute unit 230, the long term care, the free-standing SNF 240, and the hospice 260 each utilize the MDS forms and outcome for reporting and for payment. The AL 250 with “Skilled Home Care” capabilities utilizes the OASIS forms and the rehab hospital 220 uses another special assessment tool, the point being that each HDS uses a system that works best for it. It is to be understood, however, that the method and system of the present invention is not limited to any specific system, since any system of this type is included within the scope of the claims herein. Each HDS 210, 220, 230, 240, 250, 260, 270 has the ability to impact all assessment-based HDS reimbursement 212, 214, 222, 232, 242, 252, 262, 272, 274, respectively, by means of the shared data pool 202. In the specific example illustrated in FIG. 2, each HDS 210, 220, 230, 240, 250, 260, with the exception of the ambulatory clinic 270, has the ability to impact reimbursement in a two-way flow of information into and out of the shared data pool 202. The ambulatory clinic 270, impacts in a one-way flow of information simply because it is the HDS that is initiating the patient placement. In this way, the patient is placed within the CEIOS system 200 in a way that best benefits to patient, that best utilizes resources of the CEIOS system 200 and each of its component HDS, and that utilizes information from each HDS to report data for purposes of payment and reimbursement. For example, data acquired from the hospital 210 can be linked into the assisted living program 250 where appropriate to provide a complete picture of patient care to the appropriate people and for the appropriate purposes in a CEIOS system-wide approach.

Referring generally now to FIG. 3, it shows a diagram that illustrates in even greater detail a hardware and software architecture according to one embodiment of the invention and the data flow through the technology system of the CEIOS 200 that supports the shared data model outlined in FIG. 2. It is broken down into three primary sections: the “Data Translation Layer 300,” the “Data Processing Layer 400,” and the “Data Presentation Layer 500.” The overall hardware and software architecture supports modular changes to the system 200 at each layer. This means that translation, processing, or presentation modules may be easily added or removed without affecting the underlying application framework.

The Data Translation Layer's 300 sole purpose is to electronically receive input data and convert it into a standard format. This standard format is generic enough to be used for any type of input data, but descriptive enough to be useful as raw data for the Data Processing Layer 400. Any time a new input is added to the system a translator would be added to convert the data. This layer 300 handles all electronic inputs to the system 200. As shown in FIG. 3, the Data Translation Layer 300 comprises received and inputted OASIS data 310, MDS base raw data 320, rehab assessment raw data 330, doctor office data 340, and other state assessment raw data 350 from relevant HDS. This somewhat unstructured raw data 310, 320, 330, 340, 350 is translated 312, 322, 332, 342, 352 by one or more modules that are pre-programmed for translation and then inputted as “clean” data 360. This clean data 360 is then held in a server 370, which may or not be centralized, for processing. It is to be understood that virtually any format that can be used by an HDS to collect and report data is considered to be within the scope of the method and system of the present invention. The claims herein are not limited to the specific arrangement illustrated in FIG. 3 for the Data Translation Layer 300. The Data Translation Layer 300 is configured to translate any information collection format, using essentially unstructured data and making it structured standardized data.

The Data Processing Layer 400 is responsible for applying business rules to the standardized data. It is where all of the business “knowledge” resides. Each module in this layer 400 contains all of the processes necessary for a complete business need. As shown in FIG. 3, the Data Processing Layer 400 includes, for the example given, an OASIS processor 410, an MDS processor 420, a rehab hospital processor 430, a doctors' office processor 440, and other state assessment processor 450. It is to be understood that the Data Processing Layer 400 that is provided in accordance with the present invention is not limited to the processors listed here. Any and all other types of processors are within the scope of the present invention. Processor modules can be added or removed as desired or required by the system 200. The processors 410, 420, 430, 440, 450 perform calculations 460 in accordance with a pre-programmed scheme, performing one or more algorithms on the clean data 360 that has been received in a standardized format and the post-processed, or calculated, data 460 can be stored in the database or server 470, which may or may not be centralized, for use by the Data Presentation Layer 500. This layer 500 only uses the standardized post-translated data.

This last layer, the Data Presentation Layer 500, uses the results of the Data Translation and Processing Layers 300, 400 to provide usable data to system employees and customers. The presentation layer 500 can be a web page, a report, a web service, an export, or any other resource or method that the data can be used. This layer 500 contains all of the outputs of the CEIOS system 200. As shown in FIG. 3, the calculated data 470 can be exported 510 for transmission on a national reporting basis 512, to other RHIOs 516, or to other downstream software 514. The calculated data 470 can also be used in reports for feedback to the individual HDS 520, 550 that has provided raw data and in reports for corporate decisions 530 or at the CEIOS level. Here again, the specific Data Presentation Layer 500 illustrated in FIG. 3 is not a limitation of the method and system of the present invention. It is presented only for the purpose of describing a preferred embodiment of the invention, but is not limiting the claims in any way.

The CEIOS system 200 of the present invention provides a system whereby raw data can be presented in the best practice language of the HDS needing reports and using merges of data originally collected in one or more corporate-owned HDS for purposes of maximized patient treatment, maximized resource utilization and uniform data reporting for payment reimbursement and other corporate purposes. Under the method and system of the present invention, each HDS has the benefit of using its specific best practice action, all of which is documented in its specific language, but which can also operate from a multiple or single data source created by multiple corporate-owned HDS.

Additional data provided by other regional providers in the corporate entity's RHIOs can also be retrieved and made more valuable. RHIOs data that is initially received devoid of HDS best practice data details can be combined with CEIOS data to improve the value of all data. This RHIOs-wide recompiled uniform source data can then be translated to best practice language for any user in the corporate entity all further enhancing the use of the CEIOS system.

Based upon the foregoing, it will be apparent that there has been provided a new, useful and non-obvious system and method that provides for data collection and data management while coordinating health and business operation data collection across more than one HDS. It also provides a system and method that enables an entity user, such as a corporation, that owns and operates more than one type of HDS, to coordinate and control patient initial placement and or transfer between multiple HDS to optimize care, improve utilization of resources and staff, and to coordinate reimbursement outcomes for multiple HDS.

The principles of this invention having been fully explained in connection with the foregoing, we hereby claim as our invention:

1. A corporate entity information organization for sharing system that is used to collect and manage data in a multiplicity of health delivery settings for patient care, the multiplicity of health delivery settings for patient care being owned or operated by at least one corporate entity, the system comprising
a data input means,
a shared data pool, the shared data pool comprising data collected from the data input means, and
means for performing two-way sharing of data between the multiplicity of health delivery systems,
wherein patient placement is controlled and coordinated between the health delivery systems to optimize care, improve resource and staff utilization, and coordinate reimbursement outcomes for the multiplicity of health delivery settings.

2. The information sharing system of claim 1 wherein the data input means comprises means for receiving raw data from the health delivery settings and the system further comprising means for converting the raw data into a standardized clean data format.

3. The information sharing system of claim 2 wherein the system further comprises means for performing calculations using the standardized clean data in accordance with a pre-programmed scheme.

4. A system for collecting and managing data for use with multiple health delivery settings for patient care, the multiple health delivery settings for patient care being owned or operated by at least one corporate entity, the system comprising
a data translation layer,
a data processing layer, and
a data presentation layer,
wherein raw base data from the multiple health delivery settings is received by the system at the data translation layer and cleaned for processing into a standardized format, and
wherein patient placement is controlled and coordinated between the health delivery systems to accomplish one or more from a group consisting of optimization of patient care, improvement in resource and staff utilization, and coordination in reimbursement outcomes for multiple health delivery settings based upon the cleaned data in the standardized format.

5. The data collection and management system of claim 4 wherein the data processing layer comprises means for performing calculations using the standardized clean data in accordance with a pre-programmed scheme.

6. The data collection and management system of claim 5 wherein the data presentation layer comprises means for generating reports for use in business decision making by the at least one corporate entity.

7. A corporate entity information organization for sharing method that collects and manages data in a multiplicity of health delivery settings for patient care, the multiplicity of health delivery settings for patient care being owned or operated by at least one corporate entity, the method comprising the steps of
inputting data from the multiplicity of health delivery settings,
collecting input data within a shared data pool, and
performing two-way sharing of data between the multiplicity of health delivery systems,
wherein patient placement is controlled and coordinated between the health delivery systems to optimize care, improve resource and staff utilization, and coordinate reimbursement outcomes for the multiplicity of health delivery settings.

8. The information sharing method of claim 7 wherein the data input step comprises the step of receiving raw data from the health delivery settings and the method further comprises the step of converting the raw data into a standardized clean data format.

9. The information sharing method of claim 8 wherein the method further comprises the step of performing calculations using the standardized clean data in accordance with a pre-programmed scheme.

10. A method for collecting and managing data for use with multiple health delivery settings for patient care, the multiple health delivery settings for patient care being owned or operated by at least one corporate entity, the method comprising the steps of
providing a data translation layer,
providing a data processing layer, and
providing a data presentation layer,
wherein raw base data from the multiple health delivery settings is received by the system at the data translation layer and cleaned for processing into a standardized format, and
wherein patient placement is controlled and coordinated between the health delivery systems to accomplish one or more from a group consisting of optimization of patient care, improvement in resource and staff utilization, and coordination in reimbursement outcomes for multiple health delivery settings based upon the cleaned data in the standardized format.

11. The data collection and management method of claim 10 wherein the data processing layer step further comprises the step of performing calculations using the standardized clean data in accordance with a pre-programmed scheme.

12. The data collection and management method of claim 11 wherein the data presentation layer step further comprises the step of generating reports for use in business decision making by the at least one corporate entity.
